(19) United States
(12) Patent Application Publication
(10) Pub. No.: US 2012/0290497 A1
(43) Pub. Date: Nov. 15, 2012

(54) FAILURE DIAGNOSIS SYSTEM, FAILURE DIAGNOSIS DEVICE AND FAILURE DIAGNOSIS PROGRAM

(75) Inventors: Hiroyuki Magara, Yokohama (JP); Shunji Maeda, Yokohama (JP); Hisae Shibuya, Chigasaki (JP)

(73) Assignee: Hitachi, Ltd., Tokyo (JP)

(21) Appl. No.: 13/574,314

(22) PCT Filed: Nov. 25, 2010
(86) PCT No.: PCT/JP2010/071008

§ 371 Date: Aug. 1, 2012

(30) Foreign Application Priority Data
Feb. 22, 2010 (JP) 2010-035538

(51) Int. Cl. G06Q 10/00

(52) U.S. Cl. 705/345

(57) ABSTRACT

In the failure diagnosis system of the present invention, the maintenance case information including data ambiguity and a partially deficient portion is utilized even in the case where maintenance case information having a high similarity is not sufficiently provided. The failure diagnosis system is provided with: a failure diagnosis rule creation unit 31 which, by utilizing maintenance case information accumulated in the past, creates a failure diagnosis rule used for listing up candidates of maintenance parts required for recovering the equipment from a failure phenomenon; a failure diagnosis execution unit 32 which, upon occurrence of a failure, outputs the candidates of maintenance parts required for recovering from the failure phenomenon to a maintenance work assist terminal with reference to the failure diagnosis rule; and a failure diagnosis rule updating unit 33 for updating the failure diagnosis rule, and the failure diagnosis rule creation unit 31 has a factor-information link creation unit, which creates links among pieces of factor information composed of pieces of information relating to the failure phenomenon, information relating to the subject component, and information relating to the corresponding treatment in the maintenance case information accumulated in the past.

### TECHNICAL FIELD

The present invention relates to a failure diagnosis system, a failure diagnosis device, and a failure diagnosis program for assisting a maintenance work for manufacturing equipment and inspection equipment.

### BACKGROUND ART

In order to maintain the performance of manufacturing equipment and inspection equipment for a long period of time, it is necessary to appropriately carry out a maintenance work such as parts replacement regularly or upon occurrence of a failure.

Moreover, in the type of service that ensures a production ratio and quality in a predetermined level or more under a maintenance contract, the improvement of service level achieved by carrying out a failure diagnosis with high accuracy and good efficiency upon occurrence of a failure to reduce the down time for a required maintenance work such as parts replacement is the key to the improvement of a competitive force for increasing the amount of orders and is simultaneously connected directly to the improvement of profitability by the reduction of maintenance parts costs and working costs.

In the conventional failure diagnosis system, a method of creating a failure diagnosis rule by utilizing design knowledge information such as FMEA (Failure Mode and Effect Analysis) and a method of creating a failure diagnosis rule by utilizing maintenance case information have been proposed.

In particular, in the method in which the maintenance case information is utilized, as a precondition, pieces of factor information relating to a phenomenon, a component and a treatment required for creating the failure diagnosis rule have to be prepared with their mutual relationships being clearly read out in most cases. However, it is rare to find such a case where the maintenance case information is accumulated in a manner that satisfies the precondition.

In view of this problem, as a method for compensating for the deficiency of factor information required to actively utilize the accumulated maintenance case information, for example, techniques described in Japanese Unexamined Patent Application Publication No. 2005-122707 (Patent Document 1) and Japanese Unexamined Patent Application Publication No. 2006-350923 (Patent Document 2) have been known.

Patent Document 1 has described a system in which pieces of condition information such as operation-state information and application-environment information relating to the equipment are collected by utilizing sensor data or the like acquired from a sensor installed in the equipment, and based on the collected condition information, the contents of maintenance of the equipment are determined and given to a person in charge of the maintenance work. In this system, by actively utilizing the sensor data, operation state at the respective components of the equipment can be confirmed, and the corresponding contents of maintenance can be presented.

Patent Document 2 has described a system in which sets of the past maintenance case information including parts replacement are classified based on similarity of maintenance works to extract a failure diagnosis rule. In this system, with respect to ambiguity of maintenance case information and a partially deficient portion of a required factor, the maintenance case information of other products including a maintenance work having a high similarity is utilized as the maintenance case information of the corresponding product, so that a failure diagnosis rule can be created with an increased number of cases.

### PRIOR ART DOCUMENTS

### Patent Documents

Patent Document 1: Japanese Unexamined Patent Application Publication No. 2005-122707

Patent Document 2: Japanese Unexamined Patent Application Publication No. 2006-350923

### SUMMARY OF THE INVENTION

### Problems to be Solved by the Invention

In the prior art, the following problems are left. The technique of Patent Document 1 is provided on the assumption that it is utilized for the determinations of limited inspection items to be carried out in periodic inspections, and no assumption is made on the utilization of the maintenance case information including ambiguity and a partially deficient portion of required factor information. Moreover, the technique of Patent Document 2 is not suitable for the creation of a failure diagnosis rule in the case where other products including a maintenance work having a high similarity are not sufficiently present.

In view of these problems, an object of the present invention is to provide a failure diagnosis system, a failure diagnosis device and a failure diagnosis program that can effectively utilize maintenance case information including data ambiguity and a partially deficient portion even in the case where other products including a maintenance work having a high similarity are not sufficiently present.

The above and other objects and novel characteristics of the present invention will be apparent from the description of the present specification and the accompanying drawings.

### Means for Solving the Problems

The following is a brief description of an outline of the typical invention disclosed in the present application. More specifically, the typical invention disclosed in the present application is a failure diagnosis system which includes: a failure diagnosis rule creation unit which, by utilizing maintenance case information accumulated in the past, creates a failure diagnosis rule used for listing up candidates of maintenance parts required for recovering the manufacturing equipment or the inspection equipment from a failure phenomenon; a failure diagnosis execution unit which, upon occurrence of a failure, outputs the candidates of maintenance parts required for recovering from the failure phenomenon to a maintenance work assist terminal of the maintenance worker with reference to the failure diagnosis rule; and a failure diagnosis rule updating unit which, at a timing in which the maintenance case information is added or at an updating timing for every constant period, updates the failure diagnosis rule in reflection of the added maintenance case information, and the failure diagnosis rule creation unit has a factor-information link creation processing unit, which creates links among pieces of factor information composed of pieces of information relating to the failure phenomenon, information relating to a subject component, and information relating to a corresponding treatment in the maintenance case information accumulated in the past.

### Effects of the Invention

The effects obtained by typical embodiments of the invention disclosed in the present application will be briefly described below.

That is, in accordance with the effects obtained by the typical embodiments, maintenance case information including data ambiguity and a partially deficient portion can be systematically accumulated by effectively utilizing parts delivery information and sensor information derived from each equipment, so that it is possible to create a detailed and highly accurate diagnosis rule. By this means, the probability of the maintenance worker carrying out an accurate treatment is improved, and the improvement of the service level and the reduction of the working cost and storage cost can be achieved as a result of the improvement of the working speed.

### BRIEF DESCRIPTIONS OF THE DRAWINGS

FIG. 1 is an explanatory drawing that shows a maintenance service model that is supposed to be a subject to which a failure diagnosis system according to one embodiment of the present invention is applied;

FIG. 2 is a block diagram that shows a configuration of the failure diagnosis system according to the embodiment of the present invention;

FIG. 3 is a block diagram that shows a configuration of an information terminal of each module of the failure diagnosis system according to the embodiment of the present invention;

FIG. 4A is a drawing that shows a holding data structure held by a calculation information storage unit of the failure diagnosis system according to the embodiment of the present invention;

FIG. 4B is a drawing that shows a holding data structure held by a calculation information storage unit of the failure diagnosis system according to the embodiment of the present invention;

FIG. 5 is a drawing that shows a holding data structure held by a maintenance case information storage unit of the failure diagnosis system according to the embodiment of the present invention;

FIG. 6 is a drawing that shows a holding data structure held by a failure diagnosis rule storage unit of the failure diagnosis system according to the embodiment of the present invention;

FIG. 7A is a drawing that shows a holding data structure held by a phenomenon classifying condition storage unit of the failure diagnosis system according to the embodiment of the present invention;

FIG. 7B is a drawing that shows a holding data structure held by a phenomenon classifying condition storage unit of the failure diagnosis system according to the embodiment of the present invention;

FIG. 8 is a drawing that shows a holding data structure held by a replacement part information storage unit of the failure diagnosis system according to the embodiment of the present invention;

FIG. 9 is a drawing that shows a holding data structure held by a maintenance work record information storage unit of the failure diagnosis system according to the embodiment of the present invention;

FIG. 10 is a drawing that shows a holding data structure held by a sensor data storage unit 46 of the failure diagnosis system according to the embodiment of the present invention;

FIG. 11 is a flowchart that shows a failure diagnosis rule creation process of the failure diagnosis system according to the embodiment of the present invention;

FIG. 12 is a flowchart that shows a factor-information link creation process of the failure diagnosis system according to the embodiment of the present invention;

FIG. 13 is a flowchart that shows a sensor data analysis process of the failure diagnosis system according to the embodiment of the present invention;

FIG. 14 is a flowchart that shows a preferential replacement part set-up process of the failure diagnosis system according to the embodiment of the present invention;

FIG. 15 is a flowchart that shows a failure diagnosis execution process of the failure diagnosis system according to the embodiment of the present invention; and

FIG. 16 is a flowchart that shows a failure diagnosis rule updating process of the failure diagnosis system according to the embodiment of the present invention.

### BEST MODE FOR CARRYING OUT THE INVENTION

Hereinafter, embodiments of the present invention will be described in detail with reference to the accompanying drawings. Note that components having the same function are denoted by the same reference symbols throughout the drawings for describing the embodiments, and the repetitive description thereof will be omitted.

<Maintenance Service Model Assumed as Subject to Which Failure Diagnosis System is Applied>

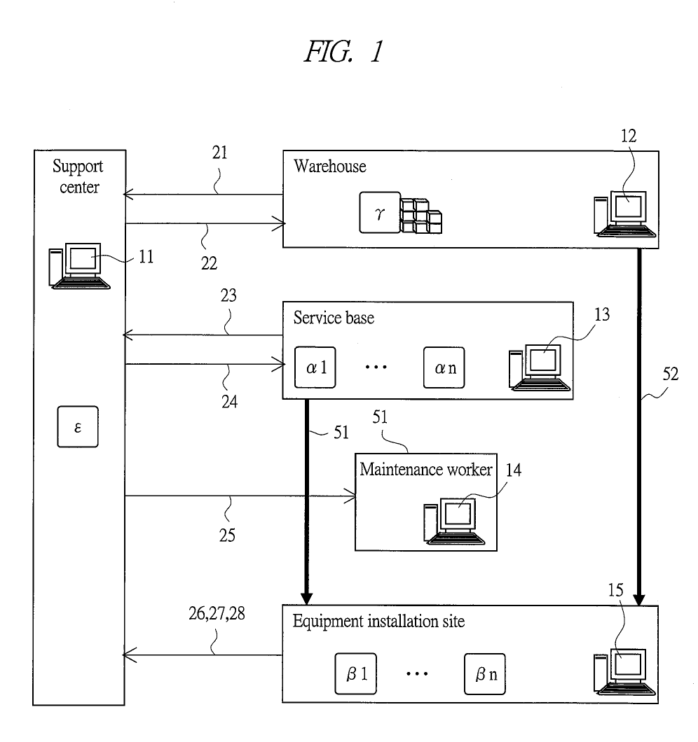

A maintenance service model that is supposed to be a subject to which a failure diagnosis system according to one embodiment of the present invention is applied will be described with reference to FIG. 1. FIG. 1 is an explanatory drawing that shows the maintenance service model that is supposed to be a subject to which the failure diagnosis system according to one embodiment of the present invention is applied.

Here, manufacturing equipment to which the failure diagnosis system of the present embodiment is applied includes power generation facilities, plants, construction equipment, aircrafts, automobiles, elevators, and others. Moreover, inspection equipment includes medical equipment, optical microscopes, and others. However, the subjects are not limited to these examples.

In FIG. 1, various data communications are carried out among a support center ε, equipment installation sites β1, β2, . . . , βn, service bases α1, α2, . . . , αn, a warehouse γ, and a maintenance worker 51.

Moreover, in each of the support center ε, equipment installation sites β1, β2, . . . , βn, service bases α1, α2, . . . , αn, and warehouse γ, a failure diagnosis rule management module 11, a sensor data management module 15, a maintenance work record information management module 13 and a replacement part information management module 12, each constituted by, for example, an information terminal and others, are installed, and the maintenance worker 51 carries a display terminal module 14 constituted by, for example, an information terminal and others.

The failure diagnosis rule management module 11, replacement part information management module 12, maintenance work record information management module 13, display terminal module 14 and sensor data management module 15 constitute the failure diagnosis system.

Moreover, in a maintenance service model that is supposed to be a subject to which the failure diagnosis system is applied, first, the support center ε determines whether or not any maintenance work is required regularly or upon receipt of alarm information 26 automatically issued in the case where any equipment is determined as being in an abnormal state based on trouble information 27 given from the user of any one of the equipment installation sites β1, β2, . . . βn or a value of sensor data 28 from a monitor device such as a sensor, a camera, or the like.

In the case where the maintenance work is required, a part delivery instruction 22 of the corresponding maintenance part 52 from the warehouse γ is given to the equipment installation site β1, β2, . . . , or βn, which is a subject of the maintenance work, and a maintenance worker dispatch instruction 24 of the maintenance worker 51 from the service base α1, α2, . . . , or αn is given. In this case, the service bases α1, α2, . . . , and αn are located for each area, and they take charge of maintenance works for a plurality of the equipment installation sites β1, β2, . . . , and βn, respectively.

Warehousing and delivery past record 21 of maintenance parts 52 and maintenance work record 23 are registered in the failure diagnosis system at each of the warehouse γ and the service bases α1, α2, . . . , and αn, and the failure diagnosis rule is created in the support center ε by actively utilizing the accumulated maintenance case information.

A failure diagnosis result 25 obtained based on the failure diagnosis rule is given as information to the maintenance worker 51 from the support center ε so as to make use of it for supporting maintenance works, and the maintenance worker 51 selects a maintenance part 52 to be replaced with reference to the failure diagnosis result 25.

<Configuration of Failure Diagnosis System>

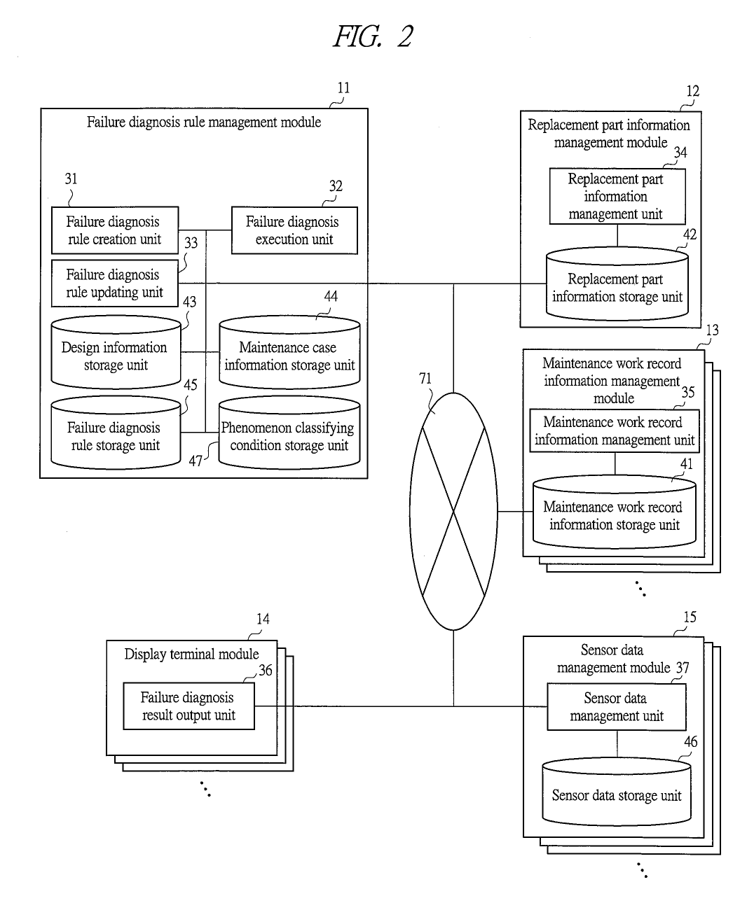

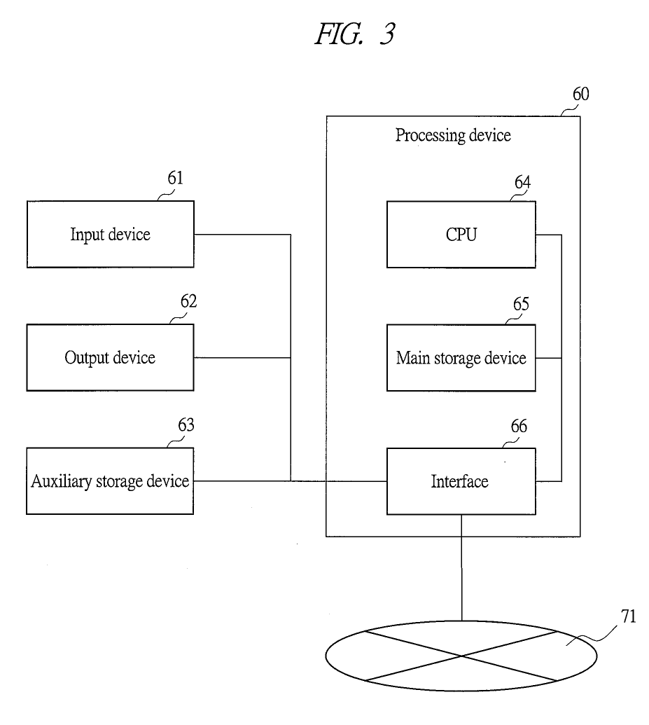

The configuration of a failure diagnosis system according to one embodiment of the present invention will be described with reference to FIGS. 1 to 3. FIG. 2 is a block diagram of a configuration of the failure diagnosis system according to the embodiment of the present invention, and it shows the configuration of each module. FIG. 3 is a block diagram showing a configuration of an information terminal of each module of the failure diagnosis system according to the embodiment of the present invention.

The failure diagnosis system shown in FIG. 2 systematizes the maintenance case information accumulated in a predetermined period of time by compensating for ambiguity of the data and a partially deficient portion thereof with using related complementary information, thereby creating a failure diagnosis rule, and it selects the maintenance part 52 to be replaced in performing a maintenance work by using the failure diagnosis rule based on the corresponding failure phenomenon.

In FIG. 2, the failure diagnosis system is constituted by a failure diagnosis rule management module 11 that creates or updates a failure diagnosis rule and executes a failure diagnosis upon occurrence of failure, a replacement part information management module 12 that manages warehousing and delivery states and storage states of maintenance parts to be used for maintenance works, a maintenance work record information management module 13 that manages work record information of maintenance works executed in the past, a display terminal module 14 that outputs the results of execution of a failure diagnosis upon occurrence of failure to a maintenance work assist terminal of each maintenance worker, and a sensor data management module 15 that manages data acquired from each sensor installed in the equipment to be a maintenance subject and transmits alarm information to the support center when the sensor data represents an abnormal value.

The failure diagnosis rule management module 11, replacement part information management module 12, maintenance work record information management module 13, display terminal module 14 and sensor data management module 15 are respectively connected to a network 71, and the respective modules can mutually transmit and receive various data and the like through the network 71. The respective modules will be described later in detail.

As shown in FIG. 3, each of the modules of the information terminals is a computer and is provided with an input device 61 such as a keyboard and a mouse, an output device 62 such as a display, an auxiliary storage device 63 and a processing device 60 that executes various programs such as a failure diagnosis program. The processing device 60 is provided with a central processing unit 64 (hereinafter, referred to as CPU), a main storage device 65, and an interface 66. The processing device 60 is connected to the input device 61, the output device 62 and the auxiliary storage device 63 through the interface 66.

In the present embodiment, the results of executions of various programs such as the failure diagnosis program that are executed on the information terminals are stored in a storage area secured in the main storage device 65. The various programs are preliminarily stored in the auxiliary storage device 63, and then read to the main storage device 65, and executed by the CPU 64. The various functions in the respective modules are realized by the executions of the various programs carried out by the CPU 64.

In the descriptions of the present embodiment, the case where the respective information terminals constituting the failure diagnosis system are realized by a general purpose information processing unit and software is taken as an example. However, this system may be realized by using, for example, hardware including hardwired logic or such hardware and a preliminarily programmed general purpose information processing unit.

Moreover, in the present embodiment, the failure diagnosis system is described as an integral processing system. However, the present invention is not limited to this. The present invention may be incorporated into another information processing system and configured so as to function as a part of it. Moreover, some part of the respective information terminal functions may be recombined or divided into small portions, or reorganized into another system.

<Functional Configurations and Holding Data Structures of Respective Modules>

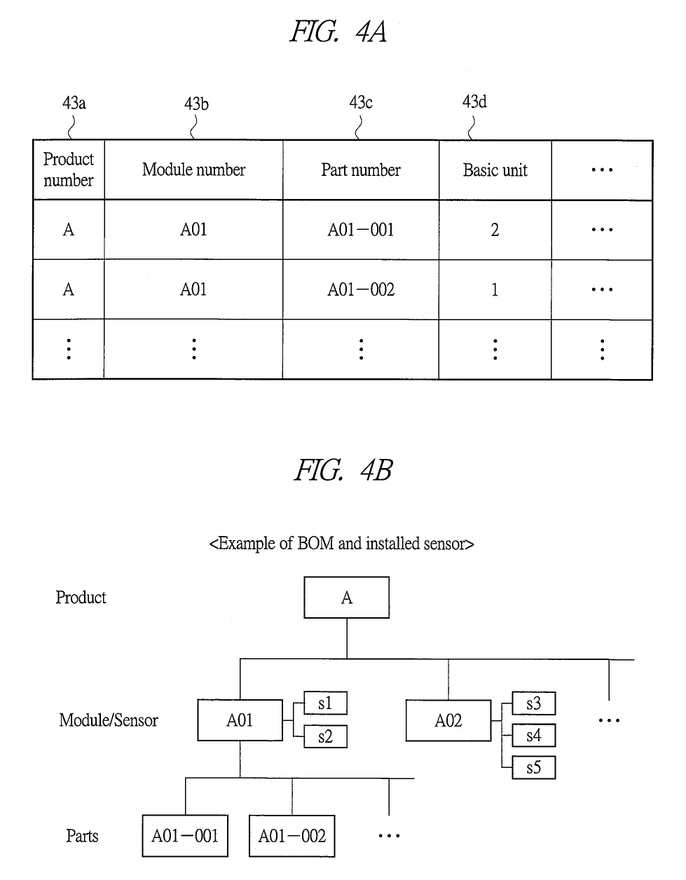

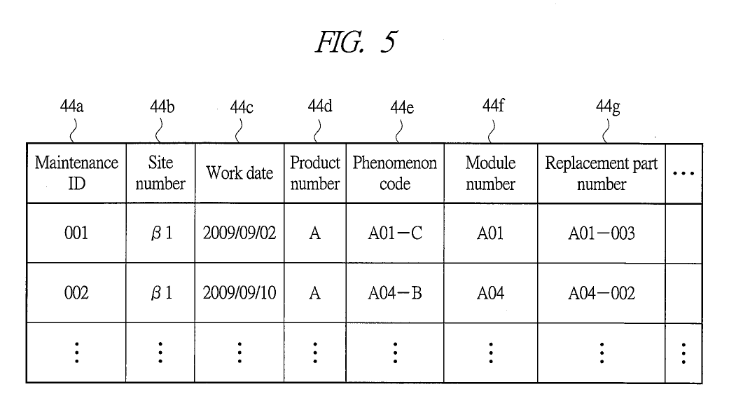

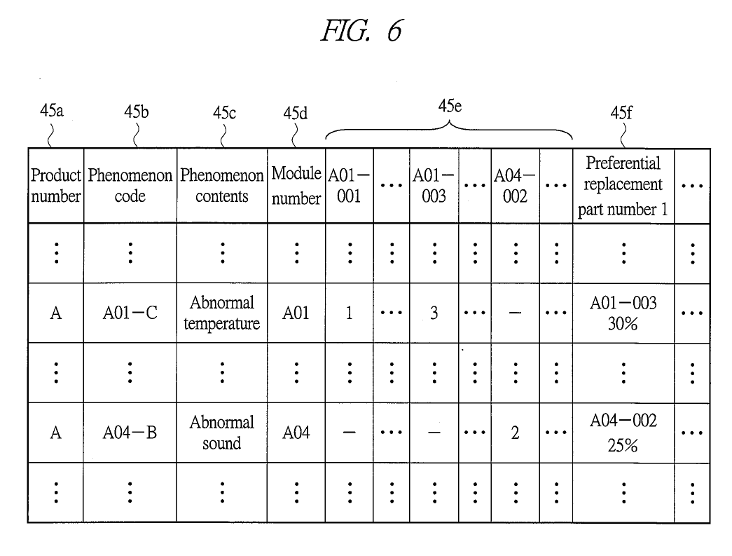

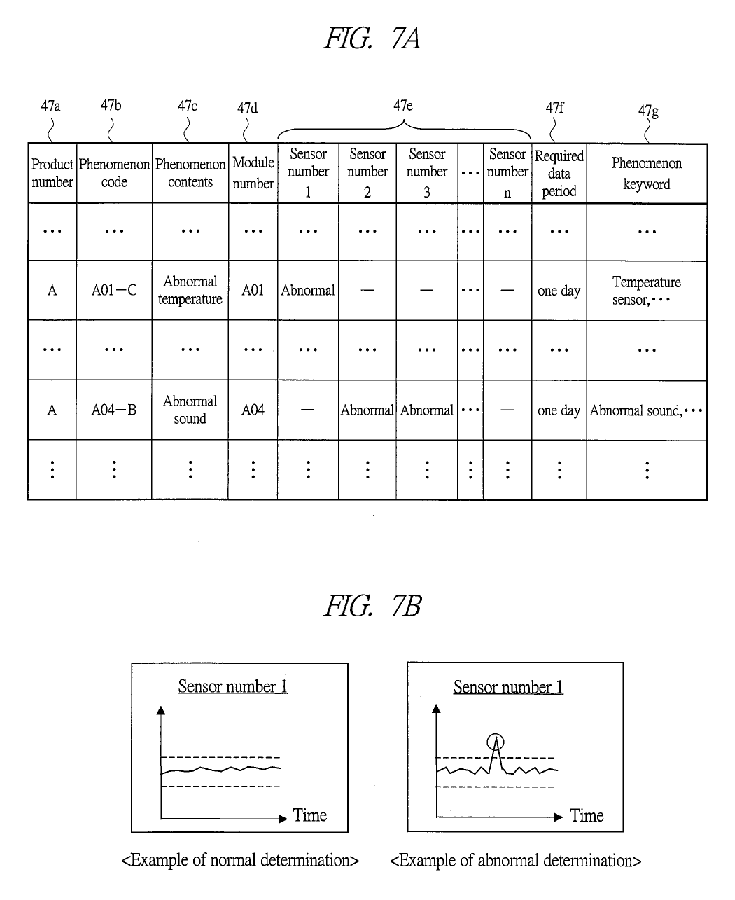

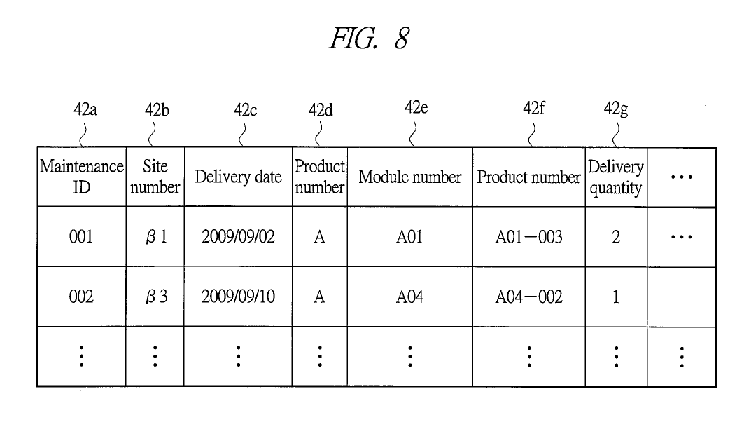

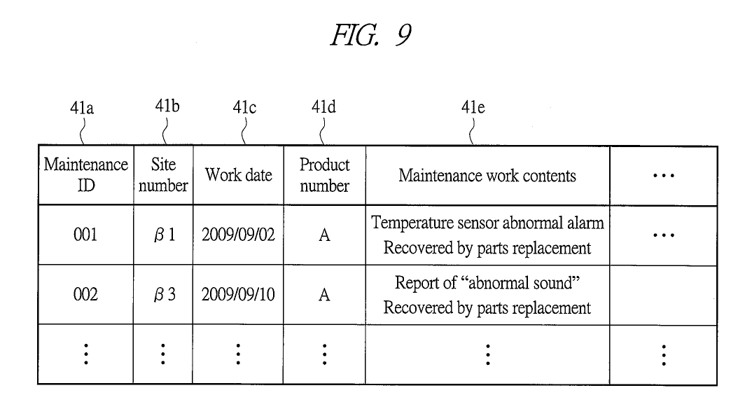

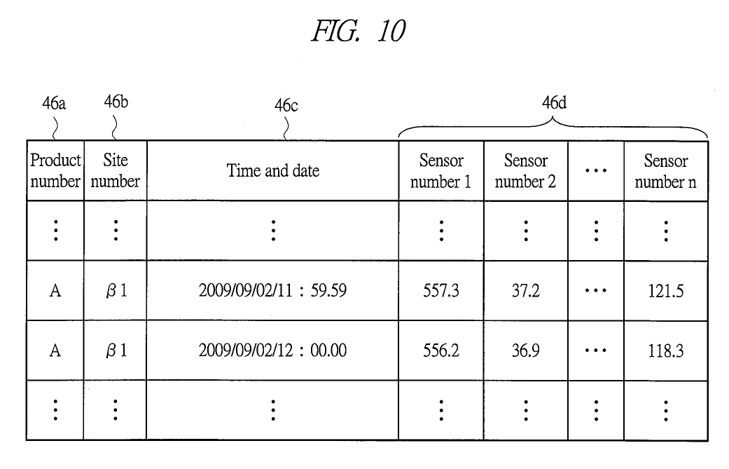

Next, functional configurations of the respective modules constituting the failure diagnosis system according to one embodiment of the present invention and holding data structures held by the respective modules will be described with reference to FIG. 2 and FIGS. 4 to 10. FIGS. 4 to 10 are drawings that show holding data structures held by the respective modules of the failure diagnosis system according to the embodiment of the present invention. FIG. 4 shows a holding data structure held by a design information storage unit 43, FIG. 5 shows a holding data structure held by a maintenance case information storage unit 44, FIG. 6 shows a holding data structure held by a failure diagnosis rule storage unit 45, FIG. 7 shows a holding data structure held by a phenomenon classifying condition storage unit 47, FIG. 8 shows a holding data structure held by a replacement part information storage unit 42, FIG. 9 shows a holding data structure held by a maintenance work record information storage unit 41, and FIG. 10 shows a holding data structure held by a sensor data storage unit 46.

In FIG. 2, the failure diagnosis rule management module 11 is constituted by a failure diagnosis rule creation unit 31 for creating a failure diagnosis rule by actively utilizing past maintenance case information, a failure diagnosis execution unit 32 for calculating and determining a maintenance part to be used in a process for a failure phenomenon at the time of maintenance work, a failure diagnosis rule updating unit 33 for updating the failure diagnosis rule in reflection of newly added maintenance case information, the design information storage unit 43 in which part configurations of equipment are stored, the maintenance case information storage unit 44 in which maintenance case information including organized relationships of pieces of factor information relating to phenomena, components, treatments, and others is stored, the failure diagnosis rule storage unit 45 in which a maintenance part to be used for a process for each failure phenomenon is stored, and the phenomenon classifying condition storage unit 47 in which conditions of behaviors of sensor data to be used for classifying failure phenomena are stored.

As shown in FIG. 4A, the design information storage unit 43 is provided with a product number field 43a, a module number field 43b, a replacement part number field 43c and a basic unit field 43d.

The contents of the design information storage unit 43 are formed based on, for example, BOM (Bills of Materials) shown in FIG. 4B. In an example shown in FIG. 6B, sensor information (S1, S2, S3, S4, S5, . . . ) relating to modules (A01, A02, . . . ) is also described.

As shown in FIG. 5, the maintenance case information storage unit 44 is provided with a maintenance ID field 44a, a site number field 44b, a work date field 44c, a product number field 44d, a phenomenon code field 44e, a module number field 44f and a replacement part number field 44g.

As shown in FIG. 6, the failure diagnosis storage unit 45 is provided with a product number field 45a, a phenomenon code field 45b, a phenomenon contents field 45c, a module number field 45d, a replacement part number field 45e and a preferential replacement part number field 45f.

As shown in FIG. 7A, the phenomenon classifying condition storage unit 47 is provided with a product number field 47a, a phenomenon code field 47b, a phenomenon contents field 47c, a module number field 47d, a sensor number field 47e, a required data period field 47f and a phenomenon keyword field 47g.

In the phenomenon classifying condition storage unit 47, information relating to failures is preliminarily stored together with phenomenon codes. For example, when any abnormality is found by each of the sensors based on determinations as shown in FIG. 7B, information relating to the abnormality is stored in the sensor number field 47e of the phenomenon classifying condition storage unit 47, and keywords relating to the phenomenon contents of the phenomenon contents field 47c are stored in the phenomenon keyword field 47g.

Moreover, the replacement part information management module 12 is constituted by a replacement part information management unit 34 that manages warehousing and delivery past records and storage states of maintenance parts to be used for maintenance works and a replacement part information storage unit 42 that stores delivery information of maintenance parts used in the past maintenance works.

As shown in FIG. 8, the replacement part information storage unit 42 is provided with a maintenance ID field 42a, a site number field 42b, a delivery date field 42c, a product number field 42d, a module number filed 42e, a part number field 42f for a replaced part, and a delivery quantity field 42g.

Moreover, the maintenance work record information management module 13 is constituted by a maintenance work record information management unit 35 for managing work record information of maintenance works carried out in the past and a maintenance work record information storage unit 41 in which information of maintenance work contents carried out in the part is stored.

As shown in FIG. 9, the maintenance work record information storage unit 41 is provided with a maintenance ID field 41a, a site number field 41b, a work date field 41c, a product number field 41d and a maintenance work contents field 41e.

Moreover, the display terminal module 14 is constituted by a failure diagnosis result output unit 36 for outputting execution results of a failure diagnosis to maintenance work assist terminals to show the execution results to each of maintenance workers.

Also, the sensor data management module 15 is constituted by a sensor data management unit 37 which manages data acquired from each sensor installed in the equipment to be a maintenance subject and transmits alarm information to the support center when the sensor data represents an abnormal value and a sensor data storage unit 46 in which data of sensors installed to monitor operation states of the equipment is stored.

As shown in FIG. 10, the sensor data storage unit 46 is provided with a product number field 46a, a site number field 46b, a time and date field 46c and a sensor number field 46d.

As described above, the respective processing units are allowed to function when the CPU 64 shown in FIG. 3 executes various programs. The detailed operations of the respective processing units will be sequentially described in the following description of a flowchart.

<Whole Process Flow of Failure Diagnosis System>

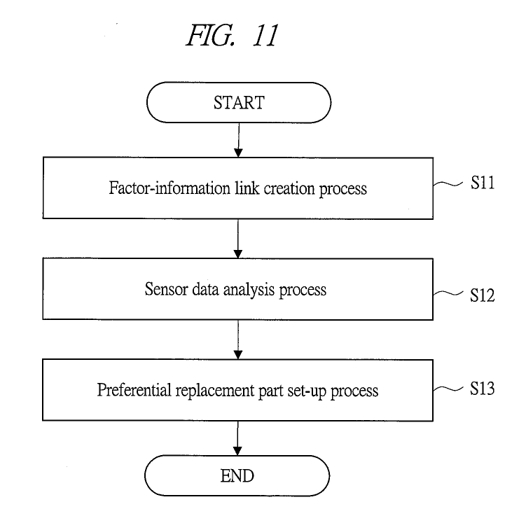

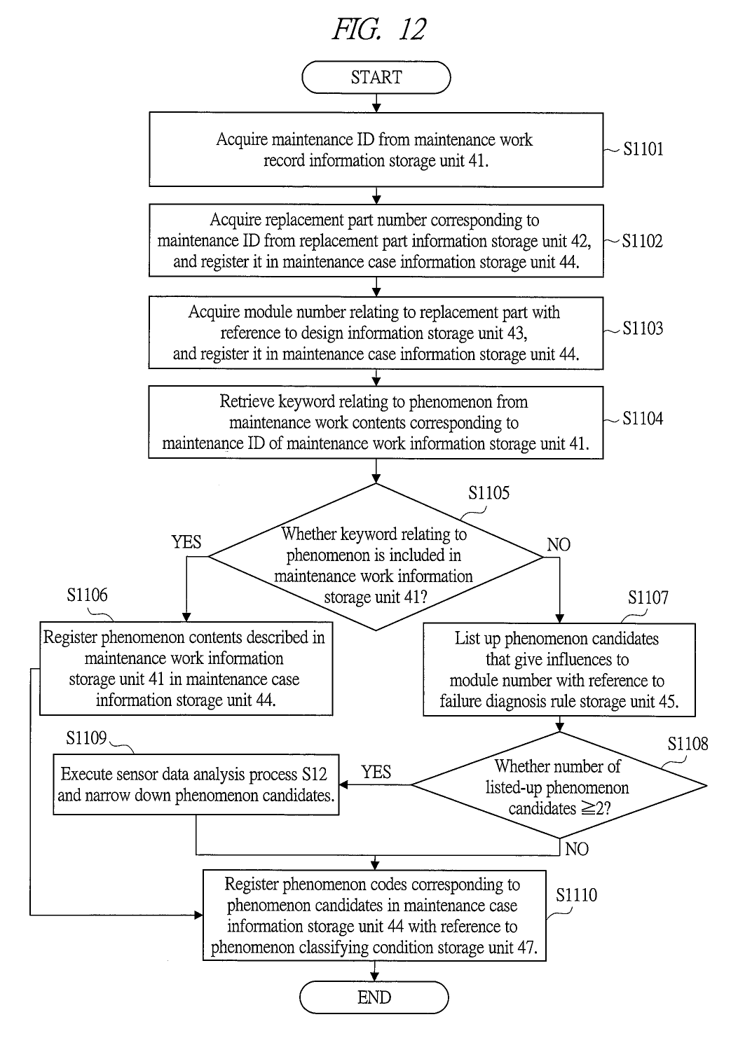

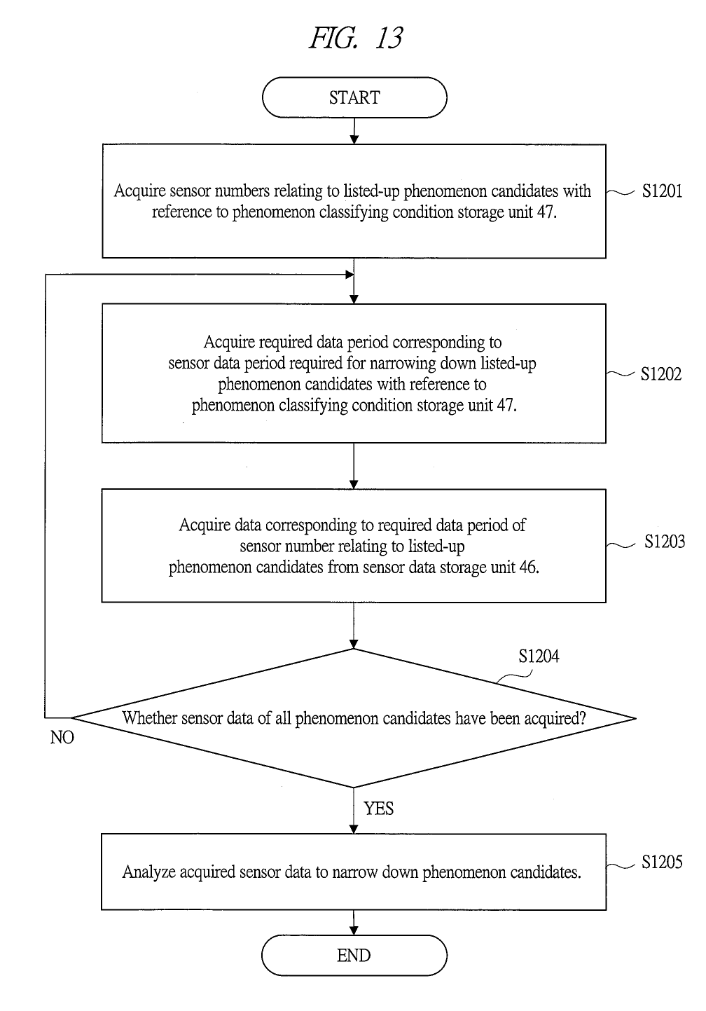

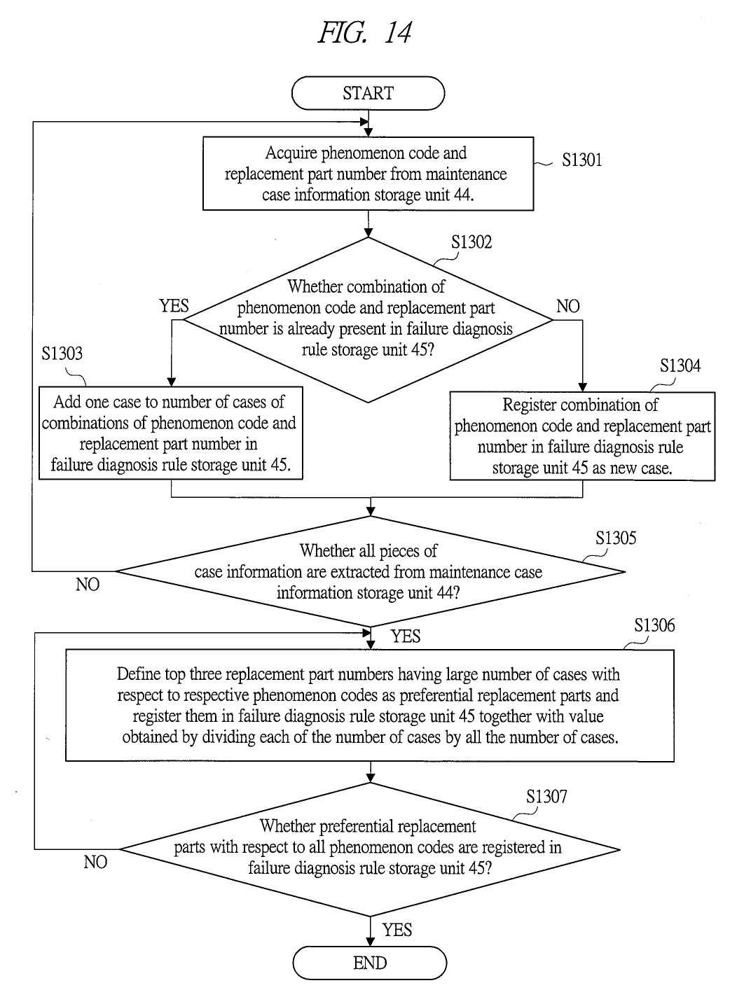

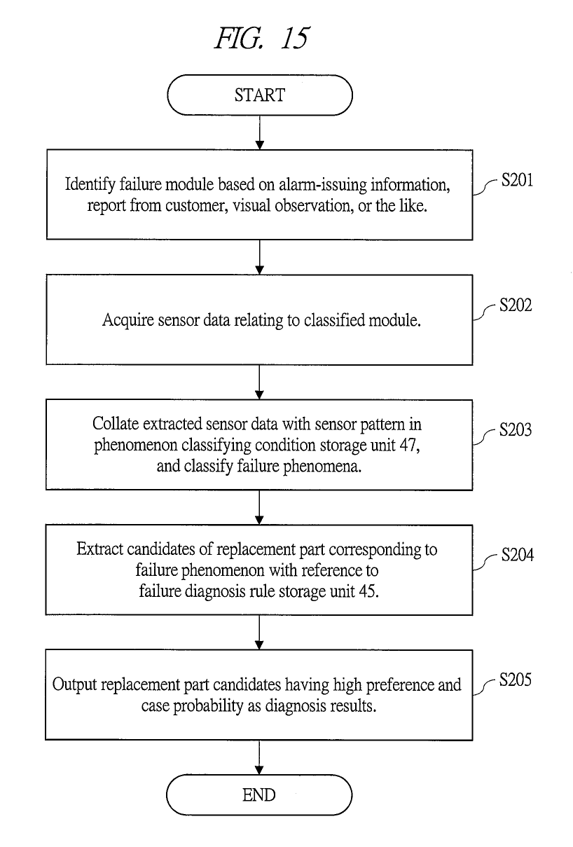

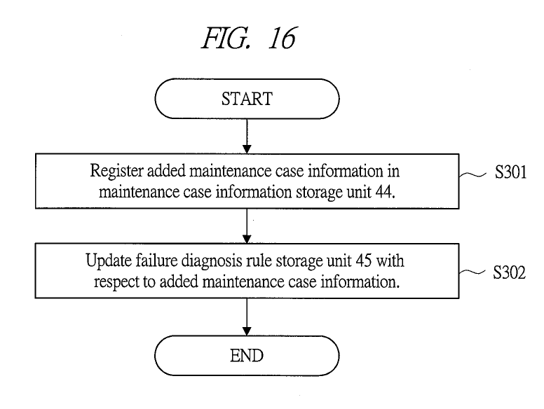

Next, the whole process flow of the failure diagnosis system according to one embodiment of the present invention will be described with reference to FIGS. 11 to 16. FIGS. 11 to 16 are flowcharts that show the flow of whole processes of the failure diagnosis system according to one embodiment of the present invention. FIG. 11 is a flowchart showing failure diagnosis rule creation process, FIG. 12 is a flowchart showing factor-information link creation process, FIG. 13 is a flowchart showing sensor data analysis process, FIG. 14 is a flowchart showing preferential replacement part set-up process, FIG. 15 is a flowchart showing failure diagnosis execution process, and FIG. 16 is a flowchart showing failure diagnosis rule updating process.

First, the processes carried out in the failure diagnosis system are, in the support center ε, a failure diagnosis rule creation process S1 in which the failure diagnosis rule creation unit 31 systematizes pieces of maintenance case information accumulated in the past to creates a failure diagnosis rule, a failure diagnosis execution process S2 in which the failure diagnosis execution unit 32 executes a failure diagnosis at the time of a maintenance work, and a failure diagnosis rule updating process S3 in which the failure diagnosis rule updating unit 33 updates the failure diagnosis rule in reflection of the latest maintenance case information.

Moreover, the execution results of the failure diagnosis are outputted to an information terminal (maintenance work assist terminal) of each of the maintenance workers 51.

“Failure Diagnosis Rule Creation Process S1”

As shown in FIG. 11, the failure diagnosis rule creation process S1 for creating a failure diagnosis rule is composed of three sub-processes.

These are a factor-information link creation process S11, a sensor data analysis process S12 and a preferential replacement part set-up process S13, and are carried out in the processing units of the failure diagnosis rule creation unit 31, that is, a factor-information link creation processing unit, a sensor data analysis processing unit and a preferential replacement part set-up unit, respectively.

In these processes carried out sequentially, links among pieces of factor information relating to a phenomenon, a component and a treatment, which are required for creating a failure diagnosis rule and are included in maintenance case information having data ambiguity and a partially deficient portion thereof and other related information, are created to systemize the maintenance cases, thereby creating a failure diagnosis rule. Note that the contents of the respective processes above will be described in detail with reference to the flowcharts described later.

‘Factor-Information Link Creation Process S11’

In the factor-information link creation process S11, pieces of factor information relating to a phenomenon, a component and a treatment are extracted from maintenance case information such as maintenance work record or the like, and after making them associated with one another, they are registered in the maintenance case information storage unit 44.

In the process flow, as shown in FIG. 12, a maintenance ID is first acquired from the maintenance work record information storage unit 41 (S1101), a replacement part number corresponding to the maintenance ID is acquired from the replacement part information storage unit 42, and these are registered in the maintenance case information storage unit 44 (S1102).

Subsequently, with reference to the design information storage unit 43, a module number relating to the replacement part number is acquired and registered in the maintenance case information storage unit 44 (S1103).

Next, based on the maintenance work contents corresponding to the maintenance ID of the maintenance work record information storage unit 41, a keyword relating to a phenomenon such as “temperature sensor”, “abnormal sound”, or others stored in the phenomenon classifying condition storage unit 47 is retrieved (S1104), and a determination is made as to whether or not the keyword relating to the phenomenon is included in the maintenance work record information storage unit 41 (S1105).

In the case where the description contents are included in S1105, the description contents relating to the phenomenon described in the maintenance work record information storage unit 41 are extracted, the phenomenon contents are registered in the maintenance case information storage unit 44 (S1106), and with reference to the phenomenon classifying condition storage unit 47, a phenomenon code corresponding to a candidate of the phenomenon is acquired and registered in the maintenance case information storage unit 44 (S1110).

In the case where no description contents are included in S1105, with reference to the failure diagnosis rule storage unit 45 in which the existing failure diagnosis rule created by utilizing design knowledge information and maintenance case information such as FMEA has been stored, candidates of the phenomenon that give influences to the module number are listed up (S1107).

Thereafter, a determination is made as to whether or not there are two or more listed-up candidates of the phenomenon (S1108), and in the case where there are two or more listed-up candidates of the phenomenon in S1108, the sensor data analysis process S12 is carried out so that the candidates of the phenomenon are narrowed down (S1109), and with reference to the phenomenon classifying condition storage unit 47, the phenomenon code corresponding to the candidate of the phenomenon is acquired and registered in the maintenance case information storage unit 44 (S1110).

In the case where there is only one listed-up candidate of the phenomenon in S1108, with reference to the phenomenon classifying condition storage unit 47, the phenomenon code corresponding to the candidate of the phenomenon is acquired and registered in the maintenance case information storage unit 44 (S1110).

‘Sensor Data Analysis Process S12’

In the sensor data analysis process S12, the two or more candidates of the phenomenon listed up in the factor-information link creation process S11 are narrowed down by utilizing sensor data. In the respective sensors, physical quantities such as a temperature, a pressure, and others are measured with respect to operation states of manufacturing equipment, inspection equipment, and others.

In the process flow, as shown in FIG. 13, with reference to the phenomenon classifying condition storage unit 47, sensor numbers relating to the listed-up candidates of the phenomenon are first acquired (S1201), and a required data period that is a sensor data period required for narrowing down the listed-up candidates of the phenomenon is acquired (S1202).

Subsequently, data corresponding to the required data period of the sensor number relating to the listed-up candidates of the phenomenon is acquired from the sensor data storage unit 46 (S1203).

Then, a determination is made as to whether or not sensor data relating to all the phenomenon candidates have been acquired (S1204), and the processes from S1202 to S1203 are repeatedly carried out until the sensor data relating to all the phenomenon candidates listed up in S1204 have been acquired.

Next, a data analysis with respect to the acquired sensor data is carried out by using a method in which the phenomenon is univocally classified by comparing a value of one piece of sensor data with a reference range or a method in which the phenomenon is classified based on deviation conditions or the like of a plurality of pieces of sensor data, thereby narrowing down the phenomenon candidates (S1205).

‘Preferential Replacement part Set-up Process S13’

In the preferential replacement part set-up process S13, a preferential replacement part number calculated in a failure diagnosis rule is set by utilizing the maintenance case information accumulated in the maintenance case information storage unit 44.

In the process flow, as shown in FIG. 14, a phenomenon code and a replacement part number are first acquired from the maintenance case information storage unit 44 (S1301), and a determination is made as to whether or not a combination of the phenomenon code and the replacement part number has already been present in the failure diagnosis rule storage unit 45 (S1302).

In the case where the combination has already been present in S1302, one case is added to the number of cases of the combination of the phenomenon code and the replacement part number in the failure diagnosis rule storage unit 45 (S1303).

In the case where the combination has not been present in S1302, the combination of the phenomenon code and the replacement part number is registered as a new case in the failure diagnosis rule storage unit 45 (S1304).

Next, a determination is made as to whether or not all the case information has been extracted from the maintenance case information storage unit 44 (S1305), and the processes from S1301 to S1304 are repeatedly carried out until all the case information has been acquired from the maintenance case information storage unit 44 in S1305.

Subsequently, the top three replacement part numbers having large number of cases with respect to the respective phenomenon codes are defined as preferential replacement part numbers and registered in the failure diagnosis rule storage unit 45 together with a case probability that is a value obtained by dividing each of the number of cases by all the number of cases (S1306).

Next, a determination is made as to whether or not the preferential replacement part numbers with respect to all the phenomenon codes have been registered in the failure diagnosis rule storage unit 45 (S1307), and the process of S1306 is repeatedly carried out until the preferential replacement part numbers with respect to all the phenomenon codes have been registered in the failure diagnosis rule storage unit 45 in S1307.

“Failure Diagnosis Execution Process S2”

In a failure diagnosis execution process S2, at the time of a maintenance work carried out on a regular basis or upon occurrence of a failure in the equipment, a diagnosis is carried out based on a failure diagnosis rule and a preferential replacement part number is given to the maintenance worker.

In the process flow, as shown in FIG. 15, a module where the failure occurs is first identified based on alarm-issuing information, a report from a customer, a visual observation, or the like (S201).

Subsequently, data corresponding to a required data period of the sensor number relating to the classified module is acquired with reference to the phenomenon classifying condition storage unit 47 (S202).

Next, a matched phenomenon code is acquired by collating the extracted sensor data with sensor patterns in the phenomenon classifying condition storage unit 47 and the failure phenomenon is classified (S203), and top candidates of the replacement parts (for example, three candidates) corresponding to the phenomenon code are extracted with reference to the failure diagnosis rule storage unit 45 (S204), and then the replacement part candidates with high preference and the case probability are outputted to the corresponding maintenance work assist terminal (S205).

“Failure Diagnosis Rule Updating Process S3”

In a failure diagnosis rule updating process S3, at a timing in which maintenance case information is added to the maintenance work record information storage unit 41 or at an updating timing for every constant period, the failure diagnosis rule is updated in reflection of the added maintenance case information.

In the process flow, as shown in FIG. 16, the process of the factor-information link creation process S11 is first carried out at the updating timing, the added maintenance case information is registered in the maintenance case information storage unit 44 (S301), and the process of the preferential replacement part set-up process S13 is carried out with respect to the maintenance case information added by the registration and the failure diagnosis rule storage unit 45 is updated (S302).

As described above, according to the present embodiment, maintenance case information including data ambiguity and a partially deficient portion thereof is systematically accumulated by utilizing parts delivery information, sensor information derived from equipment, and keywords relating to phenomena, so that a detailed and highly accurate diagnosis rule can be created.

In the foregoing, the invention made by the inventors of the present invention has been concretely described based on the embodiments. However, it is needless to say that the present invention is not limited to the foregoing embodiments and various modifications and alterations can be made within the scope of the present invention.

For example, in the present embodiment, in each of the support center ε, equipment installation sites β1, β2, . . . , βn, service bases α1, α2, . . . , αn, and warehouse γ, the failure diagnosis rule management module 11, sensor data management module 15, maintenance work record information management module 13 and replacement part information management module 12 are installed to carry out the processes as the failure diagnosis system. However, the respective modules and the respective storage units used in the respective modules maybe constituted as a failure diagnosis device composed of one information processing unit and placed at the support center ε or the like, and processes of a failure diagnosis maybe carried out by transmitting and receiving pieces of various information through the network 71.

### INDUSTRIAL APPLICABILITY

The present invention relates to a failure diagnosis system for assisting maintenance works of manufacturing equipment and inspection equipment, and it is widely applicable to a failure diagnosis process in the case where maintenance case information includes ambiguity or a partially deficient portion in required factors.

### DESCRIPTION OF REFERENCE SIGNS

ε: support center, β1, β, . . . , βn: equipment installation site, α1, α2, . . . , αn: service base, γ: warehouse, 11: failure diagnosis rule management module, 12: replacement part information management module, 13: maintenance work record information management module, 14: display terminal module, 15: sensor data management module, 31: failure diagnosis rule creation unit, 32: failure diagnosis execution unit, 33: failure diagnosis rule updating unit, 34: replacement part information management unit, 35: maintenance work record information management unit, 36: failure diagnosis result output unit, 37: sensor data management unit, 41: maintenance work record information storage unit, 41a: maintenance ID field, 41b: site number field, 41c: work date field, 41d: product number field, 41e: maintenance work contents field, 42: replacement part information storage unit, 42a: maintenance ID field, 42b: site number field, 42c: delivery date field, 42d: product number field, 42e: module number filed, 42f: replacement part number field, 42g: delivery quantity field, 43: design information storage unit, 43a: product number field, 43b: module number field, 43c: replacement part number field, 43d: basic unit field, 44: maintenance case information storage unit, 44a: maintenance ID field, 44b: site number field, 44c: work date field, 44d: product number field, 44e: phenomenon code field, 44f: module number field, 44g: replacement part number field, 45: failure diagnosis rule storage unit, 45a: product number field, 45b: phenomenon code field, 45c: phenomenon contents field, 45d: module number field, 45e: replacement part number field, 45f: preferential replacement part number field, 46: sensor data storage unit, 46a: product number field, 46b: site number field, 46c: time and date field, 46d: sensor number field, 47: phenomenon classifying condition storage unit, 47a: product number field, 47b: phenomenon code field, 47c: phenomenon contents field, 47d: module number field, 47e: sensor number field, 47f: required data period field, 47g: phenomenon keyword field, 51: maintenance worker, 52: maintenance part, 60: processing device, 61: input device, 62: output device, 63: auxiliary storage device, 64: CPU, 65: main storage device, 66: interface, 71: network

1. A failure diagnosis system, which provides a maintenance worker with candidates of a maintenance part and contents of a maintenance work required for assisting a maintenance work for manufacturing equipment or inspection equipment, the system comprising:
a failure diagnosis rule creation unit which, by utilizing maintenance case information accumulated in the past, creates a failure diagnosis rule used for listing up candidates of maintenance parts required for recovering the manufacturing equipment or the inspection equipment from a failure phenomenon;
a failure diagnosis execution unit which, upon occurrence of a failure, outputs the candidates of maintenance parts required for recovering from the failure phenomenon to a maintenance work assist terminal of the maintenance worker with reference to the failure diagnosis rule; and
a failure diagnosis rule updating unit which, at a timing in which the maintenance case information is added or at an updating timing for every constant period, updates the failure diagnosis rule in reflection of the added maintenance case information,
wherein the failure diagnosis rule creation unit has a factor-information link creation processing unit, which creates links among pieces of factor information composed of pieces of information relating to the failure phenomenon, information relating to a subject component, and information relating to a corresponding treatment in the maintenance case information accumulated in the past.

2. The failure diagnosis system according to claim 1, further comprising:
a sensor data management unit which acquires data from a monitoring device installed in the manufacturing equipment or the inspection equipment, analyzes the data, makes a determination as to a normal state or an abnormal state, and issues an alarm as to the abnormal state or a failure prediction,
wherein the failure diagnosis rule creation unit has a sensor data analysis processing unit that classifies failure phenomena based on conditions of behavior patterns of the data and narrows down phenomenon candidates.

3. The failure diagnosis system according to claim 1,
wherein the failure diagnosis rule creation unit has a preferential replacement part set-up processing unit which calculates preferential replacement parts that are maintenance parts frequently used for the recovery from each of the failure phenomena and also calculates a ratio of frequency in which the preferential replacement parts were used for the recovery from each of the failure phenomena.

4. A failure diagnosis device, which provides a maintenance worker with candidates of a maintenance part and contents of a maintenance work required for assisting a maintenance work for manufacturing equipment or inspection equipment, the device comprising:
a failure diagnosis rule creation unit which, by utilizing maintenance case information accumulated in the past, creates a failure diagnosis rule used for listing up candidates of maintenance parts required for recovering the manufacturing equipment or the inspection equipment from a failure phenomenon;
a failure diagnosis execution unit which, upon occurrence of a failure, outputs the candidates of maintenance parts required for recovering from the failure phenomenon to a maintenance work assist terminal of the maintenance worker with reference to the failure diagnosis rule;
a failure diagnosis rule updating unit which, at a timing in which the maintenance case information is added or at an updating timing for every constant period, updates the failure diagnosis rule in reflection of the added maintenance case information; and
a sensor data management unit which acquires data from a monitoring device installed in the manufacturing equipment or the inspection equipment, analyzes the data, makes a determination as to a normal state or an abnormal state, and issues an alarm as to the abnormal state or a failure prediction,
wherein the failure diagnosis rule creation unit has a factor-information link creation processing unit which creates links among pieces of factor information composed of pieces of information relating to the failure phenomenon, information relating to a subject component, and information relating to a corresponding treatment in the maintenance case information accumulated in the past, a sensor data analysis processing unit which classifies failure phenomena based on conditions of behavior patterns of the data from the sensor data management unit and narrows down the phenomenon candidates, and a preferential replacement part set-up processing unit which calculates preferential replacement parts that are maintenance parts frequently used for the recovery from each of the failure phenomena and also calculates a ratio of frequency in which the preferential replacement parts were used for the recovery from each of the failure phenomena.

5. A failure diagnosis program, which provides a maintenance worker with candidates of a maintenance part and contents of a maintenance work required for assisting a maintenance work for manufacturing equipment or inspection equipment, the program allowing a computer to execute the steps of:
by utilizing maintenance case information accumulated in the past, creating a failure diagnosis rule used for listing up candidates of maintenance parts required for recovering the manufacturing equipment or the inspection equipment from a failure phenomenon;
upon occurrence of a failure, outputting the candidates of maintenance parts required for recovering from the failure phenomenon to a maintenance work assist terminal of the maintenance worker with reference to the failure diagnosis rule;
at a timing in which the maintenance case information is added or at an updating timing for every constant period, updating the failure diagnosis rule in reflection of the added maintenance case information; and
in the step of creating the failure diagnosis rule, creating links among pieces of factor information composed of pieces of information relating to the failure phenomenon, information relating to a subject component, and information relating to a corresponding treatment in the maintenance case information accumulated in the past.

6. The failure diagnosis program according to claim 5, allowing a computer to further execute the steps of:
acquiring data from a monitoring device installed in the manufacturing equipment or the inspection equipment, analyzing the data, making a determination as to a normal state or an abnormal state, and issuing an alarm as to the abnormal state or a failure prediction, and
in the step of creating the failure diagnosis rule, classifying failure phenomena based on conditions of behavior patterns of the data and narrowing down the phenomenon candidates.

7. The failure diagnosis program according to claim 5, allowing a computer to further execute the step of:
in the step of creating the failure diagnosis rule, calculating preferential replacement parts that are maintenance parts frequently used for the recovery from each of the failure phenomena and also calculating a ratio of frequency in which the preferential replacement parts were used for the recovery from each of the failure phenomena.
